(19) United States
(12) Patent Application Publication
(10) Pub. No.: US 2026/0135767 A1
(43) Pub. Date: May 14, 2026

(54) Network configuration updating method having configuration stabilizing mechanism

(71) Applicant: REALTEK SEMICONDUCTOR CORPORATION, HSINCHU (TW)

(72) Inventors: ZHAO-MING LI, Suzhou (CN); MENG-ZHOU SHEN, Suzhou (CN); CUI DING, Suzhou (CN); YI-DONG HE, Suzhou (CN)

(21) Appl. No.: 19/346,869

(22) Filed: Oct. 1, 2025

(30) Foreign Application Priority Data
Nov. 12, 2024 (CN) 202411611864.7

(51) Int. Cl. H04L 41/12; H04L 67/12

(52) U.S. Cl. CPC H04L 41/12; H04L 67/12

(57) ABSTRACT

A network configuration updating method having configuration stabilizing mechanism used in a mesh network system is provided. Network configuration information including father node identification information, child node identification information recorded in an assistance table, length information and a configuration information identification code is configured by each of node apparatuses to further broadcast a broadcast signal including the network configuration information. The broadcast signal of any other node apparatuses is received by each of the node apparatuses to determine that the broadcast signal includes the network configuration information according to the configuration information identification code, determine an initial position of the child node identification information according to the length information, and retrieve the father node identification information and the child node identification information. The assistance table is updated according to the father node identification information and the child node identification information.

### BACKGROUND OF THE INVENTION

### 1. Field of the Invention

The present invention relates to a network configuration updating method having a configuration stabilizing mechanism.

### 2. Description of Related Art

A mesh network allows the transmission of data or control commands between network nodes by using a dynamic routing method. Such a network keeps the integrity of the connections among the nodes. When some nodes in the network topology malfunction or can not provide service, a new routing can be formed by using a leaping method to transmit the message to the target node.

When a pairing or a connection-switching among the node apparatuses in the mesh network is performed, the packets may fail to be transmitted due to the environment interference. However, even if the pairing or the connection-switching is not successfully performed, some node apparatuses may falsely determine that the connection with the other node apparatuses is successfully established or may falsely determine that the connection with the other node apparatuses is not successfully established. The assistance tables of different node apparatuses may document different connection relations of the node apparatuses due to the conditions described above such that the data transmission can not be performed correctly.

### SUMMARY OF THE INVENTION

In consideration of the problem of the prior art, an object of the present invention is to supply a network configuration updating method having a configuration stabilizing mechanism.

The present invention discloses a network configuration updating method having a configuration stabilizing mechanism used in a mesh network system that includes steps outlined below. Each of a plurality of node apparatuses is operated to be a first node apparatus such that the first node apparatus configures network configuration information that includes father node identification information of a father node apparatus of the first node apparatus, child node identification information of at least one child node apparatus documented in an assistance table stored in the first node apparatus, length information and a configuration information identification code, so as to further broadcast a broadcast signal including the network configuration information. Each of the plurality of node apparatuses is operated to be a second node apparatus such that the second node apparatus receives the broadcast signal broadcasted by any one of the other node apparatuses that operates to be the first node apparatus to determine that the broadcast signal includes the network configuration information according to the configuration information identification code, determine an initial position of the child node identification information according to the length information, and retrieve the father node identification information and the child node identification information. The assistance table is updated by the second node apparatus stored therein according to the father node identification information and the child node identification information.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a diagram of a mesh network system according to an embodiment of the present invention.

FIG. 2 illustrates a flow chart of a network configuration updating method having a configuration stabilizing mechanism according to an embodiment of the present invention.

FIG. 3 illustrates a diagram of network configuration information according to an embodiment of the present invention.

FIG. 4 illustrates a diagram of a broadcast signal according to an embodiment of the present invention.

FIG. 5 and FIG. 6 respectively illustrate a flow chart of an assistance table update process that can be used in each of the node apparatuses according to an embodiment of the present invention.

FIG. 7 illustrates a diagram of a partial beacon signal according to an embodiment of the present invention.

### DETAILED DESCRIPTION OF THE PREFERRED EMBODIMENTS

An aspect of the present invention is to provide a network configuration updating method having a configuration stabilizing mechanism to allow each of network nodes in a mesh network system to update the assistance table therein according to network configuration information in a broadcast signal from other network nodes such that the assistance tables of different network nodes can be synchronized to avoid the data transmission in the mesh network being performed incorrectly.

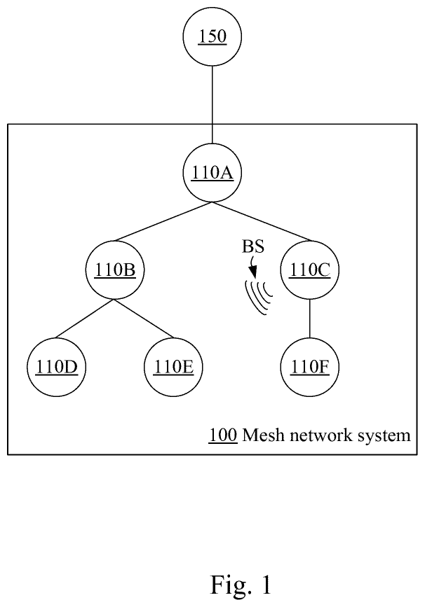

Reference is now made to FIG. 1. FIG. 1 illustrates a diagram of a mesh network system 100 according to an embodiment of the present invention. The mesh network system 100 includes node apparatuses 110A˜110F.

The mesh network system 100 is a communication network having a mesh topology that allows the node apparatuses 110A˜110F to communication each other. Each of the node apparatuses 110A˜110F includes a processing circuit, a communication circuit and a storage circuit (not illustrated) to implement a computing apparatus that has an independent address and is able to transmit and receive data.

The node apparatuses 110A˜110F may communicate with an access point apparatus 150, wherein the node apparatus 110A that is directly connected to the access point apparatus 150 is a root node apparatus. The node apparatuses connected to the access point apparatus 150 through the root node apparatus are secondary node apparatuses, e.g., the node apparatus 110B and 110C connected to the node apparatus 110A in FIG. 1. The node apparatuses connected to the access point apparatus 150 through the secondary node apparatuses are tertiary node apparatuses, e.g., the node apparatuses 110D and 110E connected to the node apparatus 110B and the node apparatus 110F connected to the node apparatus 110C illustrated in FIG. 1. It is appreciated that the configuration and the number of the node apparatuses illustrated in FIG. 1 are merely an example. In other embodiments, the node apparatuses may be configured to have more layers. The present invention is not limited thereto.

In the configuration described above, for the node apparatuses at two consecutive layers that are connected, the node apparatus at the previous layer is the father node apparatus of the node apparatus at the subsequent layer, and the node apparatus at the subsequent layer is the child node apparatus of the node apparatus at the previous layer. For example, In FIG. 1, the node apparatus 110B is the father node apparatus of the node apparatus 110D and the node apparatus 110D is the child node apparatus of the node apparatus 110B. Any one of the node apparatuses has only one father node apparatus, while a father node apparatus is allowed to have a plurality of child node apparatuses.

Each of the node apparatuses 110A˜110F uses an assistance table stored therein to document the corresponding child node apparatuses and the child node apparatuses of these child node apparatuses. For example, the assistance table of the node apparatus 110B documents the node apparatuses 110D and 110E. The assistance table of the node apparatus 110C documents the node apparatus 110F. The assistance table of the node apparatus 110A documents the node apparatus 110B˜110E.

Each of the node apparatuses 110A˜110F may document the child node apparatuses by using related information of each of the child node apparatuses, such as but not limited to media access control (MAC) or a variants thereof (e.g., information generated by performing a hash value calculation or a circular redundancy check (CRC) calculation based on the media access control).

The detail of the network configuration and the establishment of the assistance table can be referred to US patent application US20240015585A1 and is not described herein. The node apparatuses 110A˜110F may form the configuration described above according to a pairing process, where the detail of the pairing process can be referred to US patent application US20240015822A1 and is not described herein.

When a pairing or a connection switching is performed among the node apparatuses 110A˜110F, the packets may fail to be transmitted due to the environment interference. However, even if the pairing or the connection-switching is not successfully performed, some node apparatuses may falsely determine that the connection with the other node apparatuses is successfully established or may falsely determine that the connection with the other node apparatuses is not successfully established. The assistance tables of different node apparatuses 110A˜110F may document different connection relations of the node apparatuses due to the conditions described above such that the data transmission can not be performed correctly.

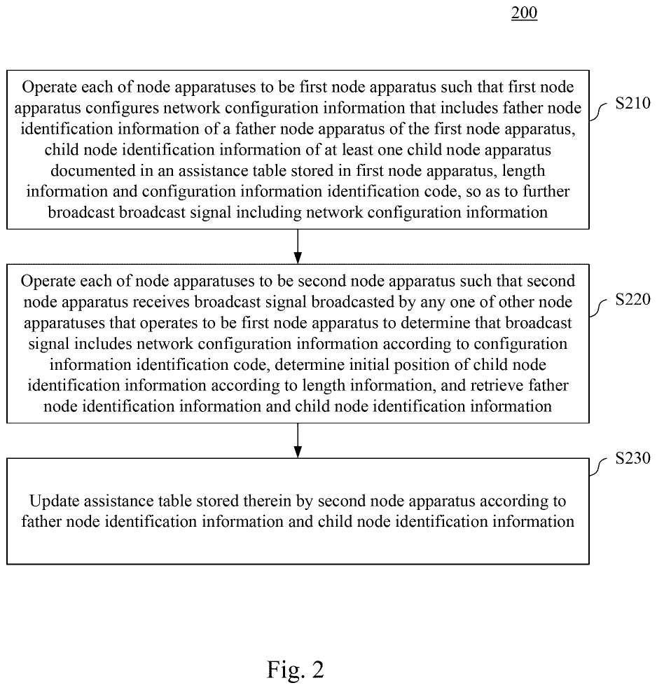

Reference is now made to FIG. 2. FIG. 2 illustrates a flow chart of a network configuration updating method 200 having a configuration stabilizing mechanism according to an embodiment of the present invention. The network configuration updating method 200 can be used in the mesh network system 100 in FIG. 1 such that the assistance table in each of the node apparatuses 110A˜110F can be synchronized by using the updating mechanism. The data transmission can be performed correctly.

In step S210, each of a plurality of node apparatuses 110A˜110F is operated to be a first node apparatus such that the first node apparatus configures network configuration information that includes father node identification information of a father node apparatus of the first node apparatus, child node identification information of at least one child node apparatus documented in an assistance table stored in the first node apparatus, length information and a configuration information identification code, so as to further broadcast a broadcast signal BS including the network configuration information.

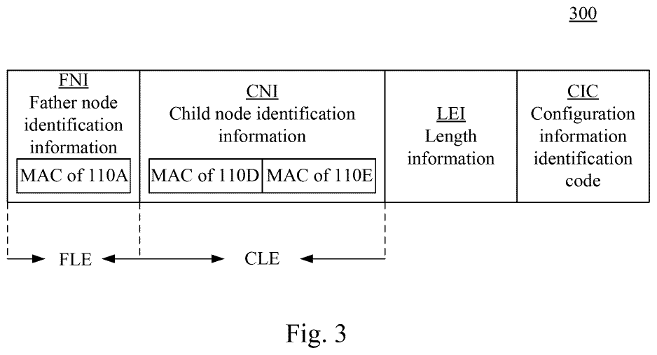

Reference is now made to FIG. 3. FIG. 3 illustrates a diagram of network configuration information 300 according to an embodiment of the present invention. The network configuration information 300 includes father node identification information FNI, child node identification information CNI, length information LEI and a configuration information identification code CIC.

In an embodiment, the father node identification information FNI is a father node media access control address of the father node apparatus or information generated by performing such as, but not limited to a cyclic redundancy check calculation on the father node media access control address. Since a node apparatus only has one corresponding father node apparatus, a father node identification information length FLE, for each of the node apparatuses, of the father node identification information FNI is fixed.

In FIG. 3, take the node apparatus 110B as an example, the father node identification information FNI included in the network configuration information 300 thereof is the media access control address of the node apparatus 110A.

In an embodiment, the child node identification information CNI is a child node media access control address of the child node apparatus or information generated by performing such as, but not limited to a cyclic redundancy check calculation on the child node media access control address. Since a node apparatus may have one or more than one corresponding child node apparatuses, a child node identification information length CLE of the child node identification information CNI is not fixed, where different node apparatuses may include the child node identification information CNI having different lengths.

In FIG. 3, take the node apparatus 110B as an example, the child node identification information CNI included in the network configuration information 300 thereof includes the media access control addresses of the node apparatuses 110D and 110E.

The length information LEI indicates a child node identification information length of the child node identification information or a sum of the child node identification information length and a fixed length of fixed length information that comprises the father node identification information disposed in front of the child node identification information.

In FIG. 3, take the node apparatus 110B as an example, the length information LEI indicates the child node identification information length CLE, or a sum of at least the child node identification information length CLE and the father node identification information length FLE.

In another embodiment, the network configuration information 300 may selectively include a basic service set identifier (BSSID, not illustrated in the figure) disposed in front of the father node identification information that is related to the access point apparatus 150. Since the length of the basic service set identifier is also fixed, the length information LEI may selectively indicate the sum of the child node identification information length CLE, the father node identification information length FLE and the length of the basic service set identifier in such an embodiment.

The configuration information identification code CIC is a string having a fixed length and a fixed content. For example, the content of the configuration information identification code CIC can be configured to include {0xAB, 0xBC, 0xCD, 0xDE, 0xEF}. However, the present invention is not limited thereto.

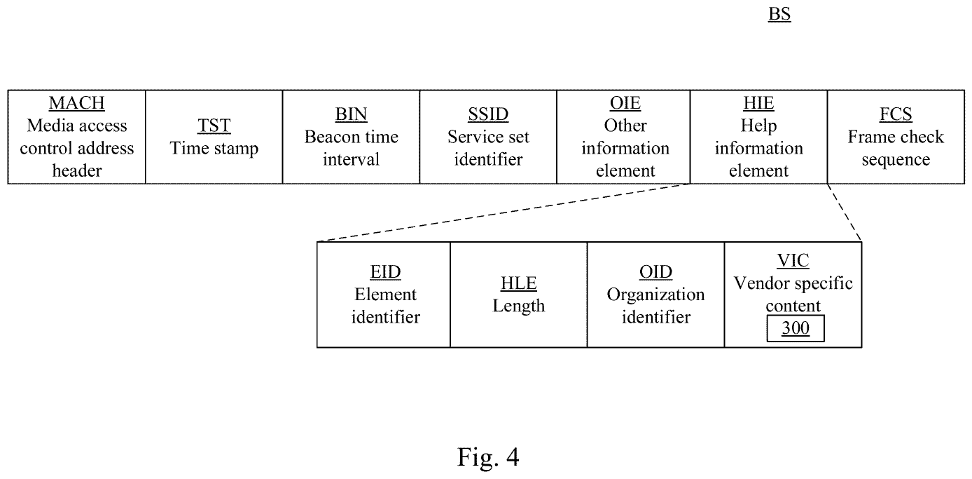

Reference is now made to FIG. 4. FIG. 4 illustrates a diagram of a broadcast signal BS according to an embodiment of the present invention. In the present embodiment, the broadcast signal BS is a beacon signal.

As illustrated in FIG. 4, the broadcast signal BS includes a plurality of entries to document the content of a media access control address header MACH, a time stamp TST, a beacon time interval BIN, a service set identifier SSID, an other information element OIE, a help information element (helper IE) HIE, and a frame check sequence FCS. The number of the other information element OIE can be one or more than one, where each of the other information element OIE and the help information element HIE may be documented by a corresponding entry of a vendor specific information element (vendor specific IE).

The help information element HIE may further include an element identifier EID, a length HLE, an organization identifier OID and a vendor specific content VIC.

In an embodiment, element identifier EID can be 221, the length HLE can be the length of the whole help information element HIE, the organization identifier OID can include identification information of the vendor, and the vendor specific content VIC may include the network configuration information 300 illustrated in FIG. 3.

Based on the configuration described above, the network configuration information 300 is disposed in the information element in front of and neighboring to a frame check sequence FCS that is at the end of the broadcast signal BS.

By using such a configuration, each of the node apparatuses 110A˜110F can be operated to be the first node apparatus to broadcast the broadcast signal BS that includes the network configuration information 300.

It is appreciated that the packet configuration of the broadcast signal BS described above is merely an example. In other embodiments, the broadcast signal BS may include the content of other entries depending on the practical requirements. The present invention is not limited thereto. Further, each of the node apparatuses in the mesh network system 100 may perform the operation described above to generate the respective broadcast signal BS, where in FIG. 1 only the broadcast signal BS broadcasted by the node apparatus 110B is illustrated.

In step S220, each of the plurality of node apparatuses 110A˜110F is operated to be a second node apparatus such that the second node apparatus receives the broadcast signal BS broadcasted by any one of the other node apparatuses that operates to be the first node apparatus to determine that the broadcast signal BS includes the network configuration information according to the configuration information identification code, determine an initial position of the child node identification information according to the length information, and retrieve the father node identification information and the child node identification information.

Take the node apparatus 110A as an example, the node apparatus 110A receives the broadcast signal BS broadcasted by the node apparatus 110B, searches the configuration information identification code CIC in front of the frame check sequence FCS illustrated in FIG. 3 and identifies that the broadcast signal BS includes the network configuration information 300. The node apparatus 110A further searches the length information LEI in the configuration information identification code CIC and further searches the initial position of the father node identification information FNI and the child node identification information CNI to retrieve these information.

In step S230, the assistance table stored therein is updated by the second node apparatus according to the father node identification information and the child node identification information.

Take the node apparatus 110A as an example, after retrieving the father node identification information FNI and the child node identification information CNI, the node apparatus 110A identifies that the node apparatus 110A itself is the father node apparatus of the node apparatus 110B and also identifies the child node apparatuses of the node apparatus 110B.

Once any one of the child node apparatus of the node apparatus 110B, e.g., the node apparatus 110E is not connected to the node apparatus 110B and is removed from the assistance table of the node apparatus 110B, the network configuration information 300 in the broadcast signal BS broadcasted by the node apparatus 110B does not include the information of the node apparatus 110E. If the assistance table of the node apparatus 110A does not document the removing of the node apparatus 110E and is not synchronized with the assistance table of the node apparatus 110B, the node apparatus 110A may retrieve the child node identification information CNI and update the assistance table of the node apparatus 110A accordingly by using a predetermined mechanism.

Once a new child node apparatus is connected to the node apparatus 110B and joins the assistance table of the node apparatus 110B, the network configuration information 300 in the broadcast signal BS broadcasted by the node apparatus 110B includes the information of the new child node apparatus. If the assistance table of the node apparatus 110A does not document the joining of the new child node apparatus and is not synchronized with the assistance table of the node apparatus 110B, the node apparatus 110A may retrieve the child node identification information CNI and update the assistance table of the node apparatus 110A accordingly by using a predetermined mechanism.

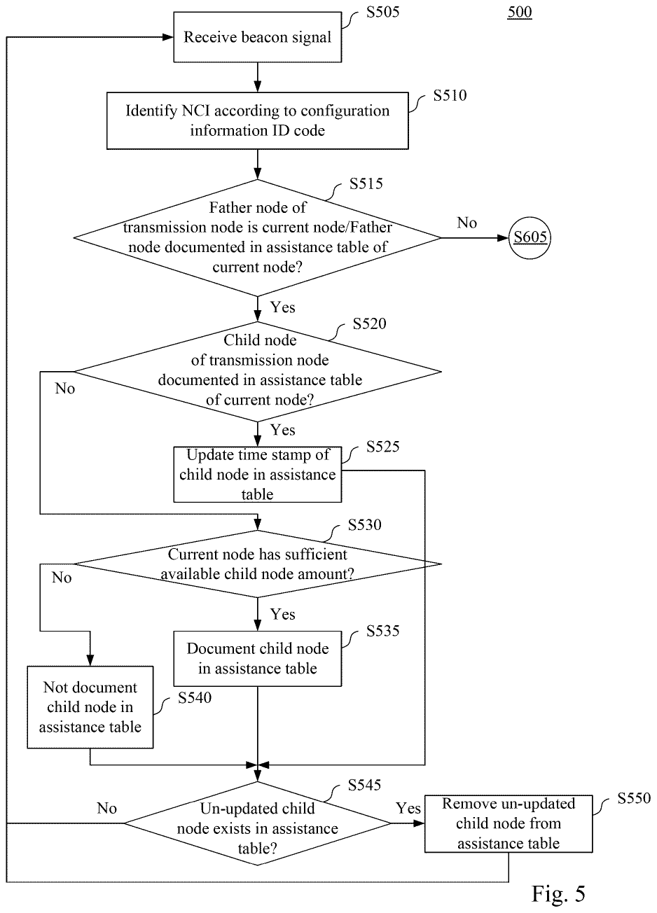

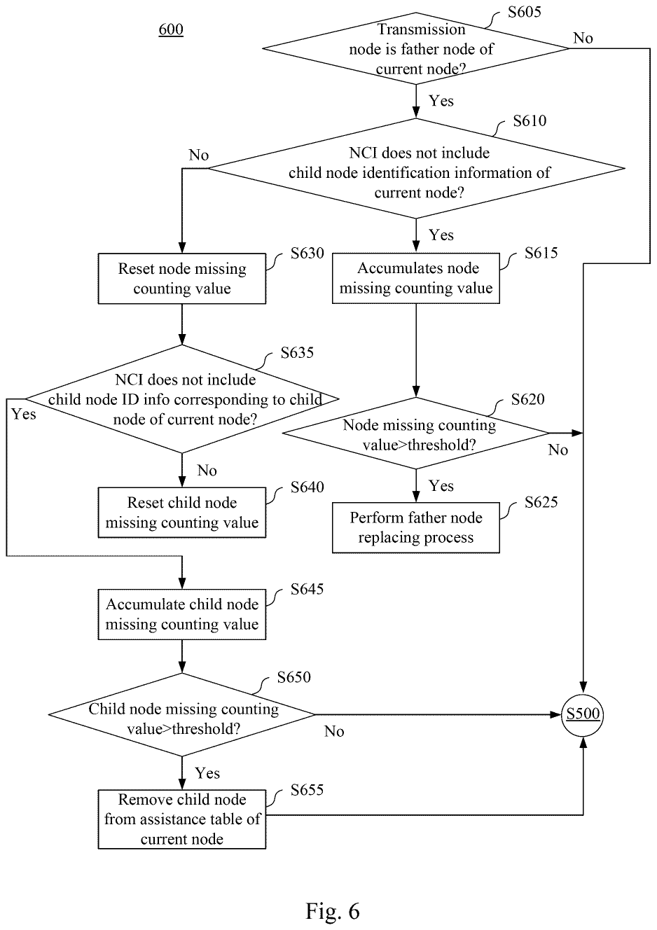

Reference is now made to FIG. 5 and FIG. 6. FIG. 5 and FIG. 6 respectively illustrate a flow chart of an assistance table update process 500 and an assistance table update process 600 that can be used in each of the node apparatuses 110A˜110F according to an embodiment of the present invention. More specifically, each of the node apparatuses 110A˜110F can be operated to be the second node apparatus to execute the assistance table update process 500 and the assistance table update process 600.

In step S505, the second node apparatus receives the beacon signal transmitted by the first node apparatus.

In step S510, the second node apparatus identifies the network configuration information (abbreviated as NCI in FIG. 5) according to the configuration information identification code.

In step S515, the second node apparatus, according to the father node identification information of the network configuration information, determines that whether the father node apparatus of the first node apparatus (which is referred to be the transmission node in the flow chart) is the second node apparatus (which is referred to be the current node in the flow chart) or whether the father node apparatus of the first node apparatus is documented in the assistance table of the second node apparatus.

In step S520, when the father node apparatus of the first node apparatus is the second node apparatus or when the father node apparatus of the first node apparatus is documented in the assistance table of the second node apparatus, the second node apparatus, according to the child node identification information of the network configuration information, determines that whether the child node apparatus of the first node apparatus is documented in the assistance table of the second node apparatus.

For example, when the node apparatus 110A receives the beacon signal BS of the node apparatus 110B (where the father node apparatus thereof is the node apparatus 110A), the node apparatus 110A determines that whether the child node apparatus of the node apparatus 110B is documented in the assistance table of the node apparatus 110A. When the node apparatus 110A receives the beacon signal of the node apparatus 110D (where the father node apparatus thereof is the node apparatus 110B), the node apparatus 110A also determines whether the child node apparatus of the node apparatus 110D is documented in the assistance table of the node apparatus 110A.

In step S525, when the child node apparatus of the first node apparatus is documented in the assistance table of the second node apparatus, the second node apparatus updates the time stamp of the child node apparatus in the assistance table.

For example, when the node apparatus 110A receives the beacon signal of the node apparatus 110B and the node apparatus 110D is documented in the assistance table of the node apparatus 110A, the node apparatus 110A updates the time stamp corresponding to the node apparatus 110D in the assistance table.

In step S530, when the second node apparatus, according to the child node identification information of the network configuration information, determines that the child node apparatus of the first node apparatus is not documented in the assistance table of the second node apparatus, whether the second node apparatus has a sufficient available child node amount is determined.

In step S535, when the second node apparatus still has the sufficient available child node amount, the second node apparatus documents the child node apparatus in the assistance table of the second node apparatus.

In step S540, when the second node apparatus does not have the sufficient available child node amount, the second node apparatus does not document the child node apparatus in the assistance table of the second node apparatus.

For example, when the node apparatus 110A receives the beacon signal of the node apparatus 110B and the node apparatus 110D is not documented in the assistance table of the node apparatus 110A, the node apparatus 110A documents the node apparatus 110D in the assistance table of the node apparatus 110A when the node apparatus 110A has the sufficient available child node amount. On the other hand, the node apparatus 110A does not document the node apparatus 110D in the assistance table of the node apparatus 110A when the node apparatus 110A does not have the sufficient available child node amount.

In step S545, after the steps S525, S535 and S540 are finished being performed, the second node apparatus determines whether at least one un-updated child node exists in the assistance table of the second node apparatus, where an un-updated time of the time stamp corresponding to the at least one un-updated child node exceeds a threshold value. When no un-updated child node exists in the assistance table of the second node apparatus, the flow goes back to the step S505 to receive the other beacon signals.

In step S550, when an un-updated child node exists in the assistance table of the second node apparatus, the second node apparatus removes the un-updated child node from the assistance table of the second node apparatus. The flow goes back to the step S505 to receive the other beacon signals.

For example, when the un-updated time of the time stamp of the node apparatus 110D exceeds the threshold value, the node apparatus 110A removes the node apparatus 110D from the assistance table of the node apparatus 110A.

It is appreciated that the steps S545 and S550 are not necessarily performed after the steps S525, S535 and S540 are finished being performed, as illustrated in the assistance table update process 500. The steps S545 and S550 can selectively be performed independently. The present invention is not limited thereto.

When the father node apparatus of the first node apparatus is determined to be not the second node apparatus and the father node apparatus of the first node apparatus is not documented in the assistance table of the second node apparatus in step S515, the flow goes to the assistance table update process 600.

In step S605, the second node apparatus, according to first node identification information further included by the beacon signal, determines whether the first node apparatus is the father node apparatus of the second node apparatus.

When the first node apparatus is not the father node apparatus of the second node apparatus, the flow goes back to the step S505 to receive the other beacon signals.

In step S610, when the first node apparatus is the father node apparatus of the second node apparatus, the second node apparatus determines whether the network configuration information (abbreviated as NCI in FIG. 6) does not include child node identification information corresponding to the second node apparatus.

For example, when the node apparatus 110B receives the beacon signal broadcasted by the node apparatus 110A, the node apparatus 110B, according to the identification information of the node apparatus 110A (e.g., the media access control address of the node apparatus 110A or the variant thereof) included by the beacon signal, determines that the node apparatus 110A is the father node apparatus of the node apparatus 110B and further determines that whether the network configuration information does not include child node identification information corresponding to the node apparatus 110B.

In step S615, when the second node apparatus determines that the network configuration information does not include child node identification information corresponding to the second node apparatus, the second node apparatus accumulates a node missing counting value.

For example, when the network configuration information in the beacon signal broadcasted by the node apparatus 110A does not include the child node identification information corresponding to the node apparatus 110B, the node apparatus 110B accumulates the node-missing counting value.

In step S620, the second node apparatus determines whether the node-missing counting value exceeds the node-missing threshold value. When the node-missing counting value does not exceed the node-missing threshold value, the flow goes back to the step S505 of the assistance table update process 500.

In step S625, when the node-missing counting value exceeds the node-missing threshold value, the second node apparatus performs a father node replacing process.

For example, when the node-missing counting value does not exceed the node-missing threshold value, the node apparatus 110B receives the other beacon signals. However, when the node-missing counting value exceeds the node-missing threshold value, the node apparatus 110B performs the father node replacing process. The performance of the father node replacing process can be referred to the description in the US patent application US20240015821A1 and is not described herein.

In step S630, when the network configuration information is determined to include the child node identification information corresponding to the second node apparatus in the step S610, the second node apparatus resets the node missing counting value.

For example, when the network configuration information in the beacon signal broadcasted by the node apparatus 110A includes the child node identification information corresponding to the node apparatus 110B, the node apparatus 110B resets the node-missing counting value.

In step S635, the second node apparatus determines whether the network configuration information does not include the child node identification information corresponding to the child node apparatus of the second node apparatus.

For example, the node apparatus 110B determines whether the network configuration information in the beacon signal broadcasted by the node apparatus 110A does not include the child node identification information corresponding to the apparatuses 110D and 110E.

In step S640, when the network configuration information includes the child node identification information corresponding to the child node apparatus of the second node apparatus, the second node apparatus resets the child node missing counting value.

For example, when the network configuration information in the beacon signal broadcasted by the node apparatus 110A is determined to include the child node identification information corresponding to the node apparatus 110D, the node apparatus 110B resets the child node missing counting value of the node apparatus 110D.

In step S645, when the network configuration information does not include the child node identification information corresponding to the child node apparatus of the second node apparatus, the second node apparatus accumulates a child node missing counting value.

For example, when the network configuration information in the beacon signal broadcasted by the node apparatus 110A is determined to not include the child node identification information corresponding to the node apparatus 110E, the node apparatus 110B accumulates the child node missing counting value of the node apparatus 110E.

In step S650, the second node apparatus determines whether the child node missing counting value exceeds a child node missing threshold value. When the child node missing counting value does not exceed the child node missing threshold value, the flow goes back to the step S505 of the assistance table update process 500.

In step S655, when the child node missing counting value exceeds the child node missing threshold value, the second node apparatus removes the child node apparatus of the second node apparatus from the assistance table of the second node apparatus. The flow goes back to the step S505 to receive other beacon signals.

For example, when the child node missing counting value does not exceed the child node missing threshold value, the node apparatus 110B receives the other beacon signals. However, when the child node missing counting value exceeds the child node missing threshold value, the node apparatus 110B removes the node apparatus 110E from the assistance table of the node apparatus 110B.

By using the mechanism described above, the assistance table of each of the node apparatuses 110A˜110F in the mesh network system 100 can be updated according to the network configuration information in the beacon signal to synchronize the assistance table to avoid the data transmission in the mesh network being performed incorrectly.

In an embodiment, when each of the node apparatuses 110A˜110F is operated to be the first node apparatus, the network configuration information may selectively further include an available child node amount of the first node apparatus in the network configuration information besides the information described above. The root node apparatus 150 may calculate a sum of the available child node amounts of all the node apparatuses 110A˜110F to allow a new node apparatus to join the mesh network system 100 when the sum is not smaller than an available threshold value.

In the embodiments described above, the condition that each of the node apparatuses 110A˜110F broadcasts a complete beacon signal is used as an example. However, in some embodiments, the broadcast signal BS broadcasted by each of the node apparatuses 110A˜110F can be a partial beacon signal or a probe response signal that does not include other information elements that is unrelated to the network configuration information.

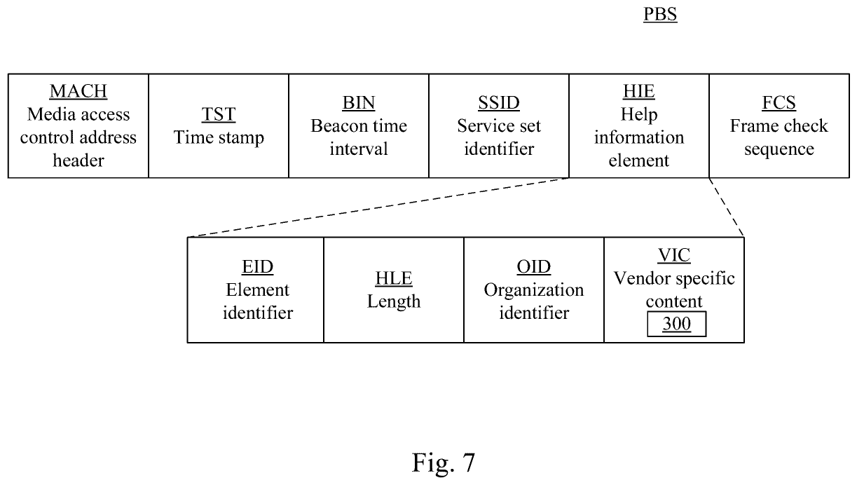

Reference is now made to FIG. 7. FIG. 7 illustrates a diagram of a partial beacon signal PBS according to an embodiment of the present invention.

The partial beacon signal PBS can be such as, but not limited to a form that removes the other information element OIE from the broadcast signal BS in FIG. 4, with only the help information element HIE remaining. As a result, as illustrated in FIG. 7, the partial beacon signal PBS includes the content of a media access control address header MACH, a time stamp TST, a beacon time interval BIN, a service set identifier SSID, a help information element HIE and a frame check sequence FCS without including the content of the other information element OIE. The information corresponding to the entries described above is identical to those in FIG. 4 and is not described herein.

Besides, the probe response signal is a signal generated by a node apparatus in response to a probe signal sent by other node apparatuses and can be configured to only carry necessary information and the help information element HIE without including the content of the other information element OIE.

By using the partial beacon signal or the probe response signal, the signal collision in the mesh network system 100 can be avoided when the number of the node apparatuses is larger since the signal length is shorter. The possibility of the data loss can be reduced.

In summary, the present invention discloses the network configuration updating method having the configuration stabilizing mechanism allows each of network nodes in a mesh network system to update the assistance table therein according to network configuration information in a broadcast signal from other network nodes such that the assistance tables of different network nodes can be synchronized to avoid the data transmission in the mesh network being performed incorrectly.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A network configuration updating method having a configuration stabilizing mechanism used in a mesh network system, comprising:
operating each of a plurality of node apparatuses to be a first node apparatus such that the first node apparatus configures network configuration information that comprises father node identification information of a father node apparatus of the first node apparatus, child node identification information of at least one child node apparatus documented in an assistance table stored in the first node apparatus, length information and a configuration information identification code, so as to further broadcast a broadcast signal comprising the network configuration information;
operating each of the plurality of node apparatuses to be a second node apparatus such that the second node apparatus receives the broadcast signal broadcasted by any one of the other node apparatuses that operates to be the first node apparatus to determine that the broadcast signal comprises the network configuration information according to the configuration information identification code, determine an initial position of the child node identification information according to the length information, and retrieve the father node identification information and the child node identification information; and
updating the assistance table by the second node apparatus stored therein according to the father node identification information and the child node identification information.

2. The network configuration updating method of claim 1, wherein the father node identification information is a father node media access control (MAC) address of the father node apparatus or is generated by a calculation performed according to the father node media access control address, and the child node identification information is a child node media access control address of the child node apparatus or is generated by a calculation performed according to the child node media access control address.

3. The network configuration updating method of claim 1, wherein the configuration information identification code is a string having a fixed length and a fixed content.

4. The network configuration updating method of claim 1, wherein the network configuration information is disposed in an information element (IE) in front of a frame check sequence (FCS) that is at the end of the broadcast signal.

5. The network configuration updating method of claim 1, wherein the broadcast signal is a beacon signal, a partial beacon signal that does not comprise a plurality of other information elements unrelated to the network configuration information or a probe response signal.

6. The network configuration updating method of claim 1, wherein the length information indicates a child node identification information length of the child node identification information or a sum of the child node identification information length and a fixed length of fixed length information that comprises the father node identification information disposed in front of the child node identification information.

7. The network configuration updating method of claim 6, wherein the fixed length information further comprises a basic service set identifier (BSSID) disposed in front of the father node identification information that is related to an access point apparatus connected to the mesh network system.

8. The network configuration updating method of claim 1, further comprising:
determining, by the second node apparatus and according to the father node identification information of the network configuration information, that the father node apparatus of the first node apparatus is the second node apparatus or the father node apparatus of the first node apparatus is documented in the assistance table of the assistance table;
determining, by the second node apparatus and according to the child node identification information of the network configuration information, that the at least one child node apparatus of the first node apparatus is documented in the assistance table of the second node apparatus so as to update a time stamp corresponding to the at least one child node apparatus in the assistance table;
determining, by the second node apparatus and according to the child node identification information of the network configuration information, that the at least one child node apparatus of the first node apparatus is not documented in the assistance table of the second node apparatus so as to document the at least one child node in the assistance table of the second node apparatus when the second node apparatus has a sufficient available child node amount;
determining, by the second node apparatus and according to the child node identification information of the network configuration information, that the at least one child node apparatus of the first node apparatus is not documented in the assistance table of the second node apparatus so as to not document the at least one child node in the assistance table of the second node apparatus when the second node apparatus does not have the sufficient available child node amount; and
determining, by the second node apparatus, that at least one un-updated child node exists in the assistance table of the second node apparatus, where an un-updated time of the time stamp corresponding to the at least one un-updated child node exceeds a threshold value, so as to remove the at least one un-updated child node from the assistance table of the second node apparatus.

9. The network configuration updating method of claim 1, further comprising:
determining, by the second node apparatus and according to first node identification information further comprised by the broadcast signal, that the first node apparatus is the father node apparatus of the second node apparatus;
determining, by the second node apparatus, that the network configuration information does not comprise the child node identification information corresponding to the second node apparatus, so as to accumulate a node missing counting value and perform a father node replacing process when the node missing counting value exceeds a node missing threshold value;
determining, by the second node apparatus, that the network configuration information comprises the child node identification information corresponding to the second node apparatus, so as to reset the node missing counting value;
determining, by the second node apparatus, that the network configuration information comprises the child node identification information corresponding to at least one child node apparatus of the second node apparatus, so as to reset a child node missing counting value; and
determining, by the second node apparatus, that the network configuration information does not comprise the child node identification information corresponding to at least one child node apparatus of the second node apparatus, so as to accumulate the child node missing counting value and remove the at least one child node apparatus from the assistance table of the second node apparatus when the child node missing counting value exceeds a child node missing threshold value.

10. The network configuration updating method of claim 1, wherein the network configuration information further comprises an available child node amount of the first node apparatus, and a root node apparatus of the plurality of node apparatuses calculates a sum of the available child node amounts of all the other node apparatuses, so as to allow a new node apparatus joining the mesh network system when the sum is not smaller than an available threshold value.
